(19) United States
(12) Patent Application Publication
(10) Pub. No.: US 2007/0253521 A1
(43) Pub. Date: Nov. 1, 2007

(54) Nuclear Reactor

(76) Inventors: Mark Nolan Mitchell, Riviera (ZA); Johann Vorster, Pinehurst (ZA)

Correspondence Address: SCHWEGMAN, LUNDBERG & WOESSNER, P.A., P.O. BOX 2938, MINNEAPOLIS, MN, 55402, US

(21) Appl. No.: 11/573,615

(22) PCT Filed: Aug. 8, 2005
(86) PCT No.: PCT/IB05/52627

§ 371 Date: Feb. 12, 2007

(30) Foreign Application Priority Data
Aug. 13, 2004 (ZA) 2004/1194

(51) Int. Cl. G21C 3/56

(52) U.S. Cl. 376/383

(57) ABSTRACT

This invention provides a support for supporting a reflector for a high temperature gas cooled nuclear reactor. The support includes a plurality of straps which extend around the reflector. Each strap includes interconnected segments. The segments are formed of metal and the segments are formed of fibre reinforced ceramic so that the coefficient of thermal expansion of the strap corresponds to that of the reflector. The invention also provides a high temperature gas cooled nuclear reactor and a method of supporting a reflector of a high temperature gas cooled nuclear reactor.

THIS INVENTION relates to a nuclear reactor. More particularly it relates to a support strap for use in supporting a reflector of a nuclear reactor. It further relates to a nuclear reactor and to a method of supporting a reflector of a high temperature gas cooled reactor.

The core internals, which define a cavity within which nuclear fuel is receivable, of high temperature gas cooled nuclear reactors of which the Inventors are aware are often manufactured of carbon materials such as graphite. These carbon materials are supported by core support components that are manufactured from metal (ferrite or austenitic steel). However, owing to the difference in the coefficient of thermal expansion of these materials, as well as variations and localized differences in operating temperature, different thermal expansions can result.

High temperature gas cooled pebble bed reactors typically have a core barrel formed of steel and an outer reflector formed of graphite blocks contained with clearance within the core barrel. Core support components are positioned in the space between the core barrel and the graphite blocks. Differences in the coefficient of thermal expansion between the reflector and the metallic support can lead to generation of internal stresses or the generation of leak flow paths in the reflector.

Prior art attempts to address this problem have been complex and relatively expensive.

It is an object to provide means which the Inventors believe will at least alleviate this problem.

According to one aspect of the invention there if provided a support for use in supporting a reflector of a high temperature gas cooled nuclear reactor which support comprises a strap which can be positioned around a reflector to be supported and which includes a plurality of interconnected segments some of which are formed of metal and others of which are formed of a fibre reinforced ceramic.

The strap may include alternating segments of metal and fibre reinforced ceramic.

The metal may be austenitic steel, typically Grade 316.

Adjacent segments of the strap may be interconnected in a manner which permits limited relative movement between adjacent segments.

In a preferred embodiment of the invention adjacent segments are hingedly interconnected.

At least one segment may have a locating formation which serves in use to locate the support circumferentially relative to a reflector being supported by the support.

Each of at least some of the metal segments may have an inwardly directed reflector contact surface, the or each locating formation being in the form of a protrusion which protrudes from the reflector contact surface and which engages, in use with a complementary recess in the reflector.

Each of at least some of the segments may have at least one outwardly directed stabilizing or core barrel contact formation

According to another aspect of the invention there is provided a high temperature gas cooled nuclear reactor which includes

a core having a reflector which defines at least partially a core cavity; and

at least one segmented support strap positioned around the reflector to provide support thereto, the support strap comprising a plurality of interconnected segments, some of the segments being formed of a material which has a higher coefficient of thermal expansion than the material of the reflector and other segments being formed of a material which has a lower coefficient of thermal expansion than the material of the reflector, the segments being configured such that the coefficient of thermal expansion of the strap corresponds to that of the core.

It will be appreciated that the expansion of the reflector in use is due not only to the increase in temperature of the reflector but also to the increase in temperature of the components such as fuel and central structures contained within the reflector. For this reason, the expansion of the strap is matched to the actual expansion of the reflector or the core as a whole taking all factors into account.

The reflector may be formed a plurality of graphite blocks, and the support strap may be a strap as described above.

The reflector may be generally cylindrical and have an axis which extends vertically, the reactor including a plurality of support straps which extend around the periphery of the reflector at vertically spaced apart positions.

The reflector may include, on an outer surface thereof, annular recesses within which portions of the straps are receivable which serve to locate the straps vertically relative to the reflector.

Each of at least some of the blocks forming an outer surface of the reflector may have an outer surface having a planar central face and two planar outer faces positioned on opposite sides of the central face and inclined rearwardly therefrom, each of at least some of the segments of the support strap having an inwardly directed reflector contact surface which extends parallel with in close proximity to or in abutment with the central face of one of the blocks.

Adjacent outer faces of adjacent blocks may be co-planar. Each outer face may have a width which is about half of the width of each central face so that the reflector has a plurality of circumferentially spaced planar faces of approximately the same width.

The nuclear reactor may include locating means for locating the or each strap circumferentially relative to the reflector. The locating means may include a protrusion which protrudes from the reflector contact surface of at least one of the segments and which is receivable in a complementary recess in the central face of one of the blocks.

The segments of the or each support strap are selected such that the overall thermal expansion of the or each strap matches that of the reflector and the pebble bed contained therein. Adjustment of the desired expansion of the strap can be achieved by varying the relative lengths of the segments of the straps and/or the materials used. Adjacent segments may be hingedly interconnected.

The nuclear reactor may include a core barrel within which the core is contained, an outer surface of the reflector being spaced radially inwardly from an inner surface of the core barrel so that an annular gap is defined between the reflector and the core barrel over at least part of the height of the reflector, at least some of the segments of the or each strap having stabilizing formations which protrude outwardly from the respective segments and which, under normal operating conditions and loads, are clear of the core barrel and which when the reactor is subjected to abnormal loads, such as may be encountered during a seismic event, make contact with the core barrel and thereby serve to stabilize the core.

The stabilizing formations may be adjustable to permit the spacing between the stabilizing formations and the core barrel to be set as desired. Further, the stabilizing formations may have damping properties to reduce shock loading on the core and the core barrel during a seismic event.

According to yet another aspect of the invention there is provided A method of supporting a reflector of a high temperature gas cooled nuclear reactor which method includes positioning at least one segmented support strap, comprising segments some of which are formed of a material having a higher coefficient of thermal expansion than the material of the reflector and others of which have a coefficient of thermal expansion which is less than that of the material of the reflector such that the coefficient of thermal expansion of the strap corresponds to that of the reflector, around the reflector to provide support thereto.

The support strap may be a support strap as described above.

The method may include positioning a plurality of support straps around the reflector at spaced apart positions.

The invention will now be described, by way of example, with reference to the accompanying diagrammatic drawings.

In the drawings:

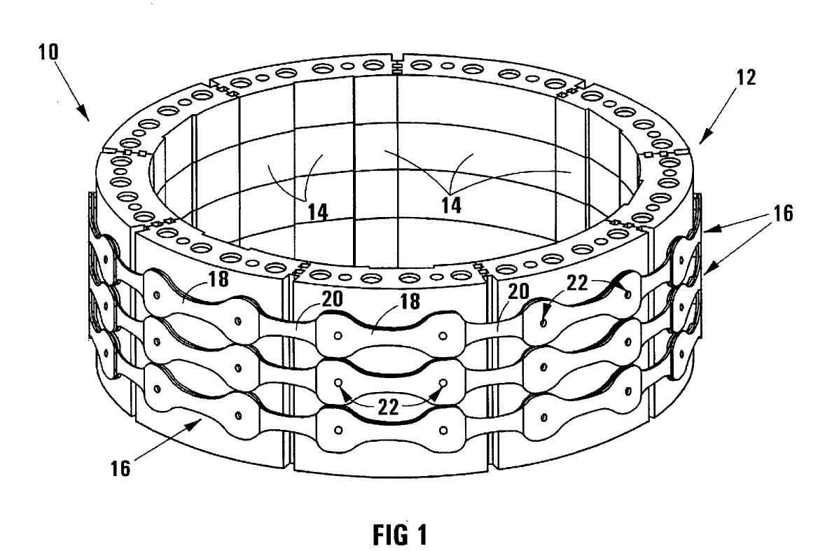

FIG. 1 shows a three-dimensional view of part of a nuclear reactor in accordance with the invention;

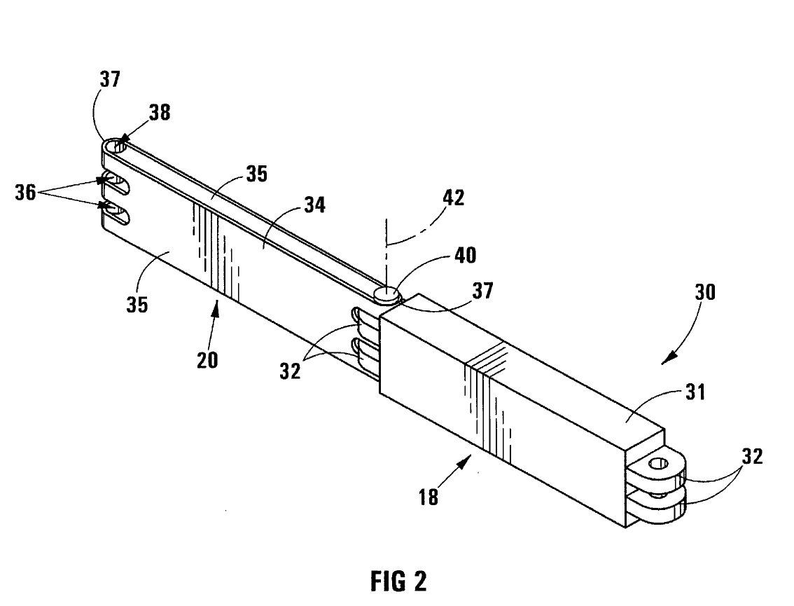

FIG. 2 shows a three-dimensional view of part of a support strap in accordance with the invention;

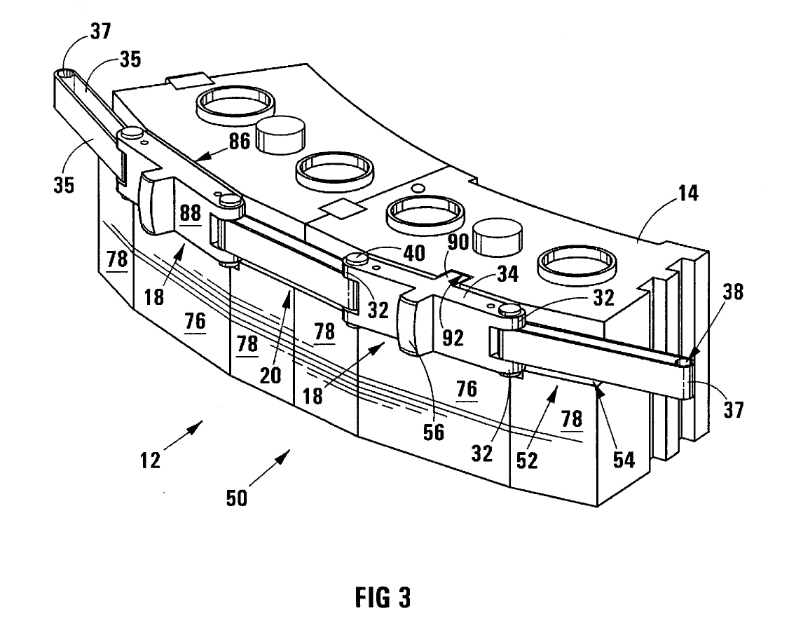

FIG. 3 shows a three-dimensional view of part of another reactor in accordance with the invention incorporating yet another support strap in accordance with the invention; and

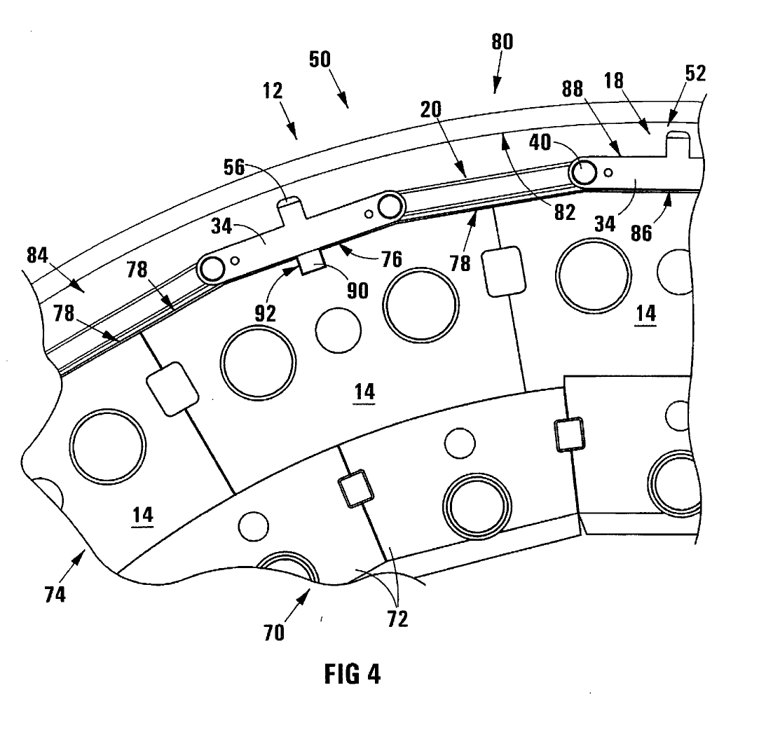

FIG. 4 shows a plan view of part of the nuclear reactor of FIG. 3.

In FIG. 1 of the drawings, reference numeral 10 refers generally to part of a nuclear reactor in accordance with the invention. The nuclear reactor 10 is a high temperature gas cooled reactor such as a pebble bed reactor and includes a side or outer reflector 12 part of which is shown in the drawing, formed from a plurality of interconnected graphite blocks 14.

The reactor 10 includes a support structure in the form of a plurality of support straps 16 which extend around the periphery of the reflector 12 at vertically spaced positions.

Each strap 16 includes alternating segments 18, 20. The segments 18 are formed of austenitic stainless steel, particularly Grade 316, and the segments 20 are formed of carbon fibre reinforced carbon.

The segments 18, 20 are waisted to provide them with a generally dumbbell profile. Each of the segments 18 has a recess extending longitudinally inwardly from each end thereof within which an end portion of an adjacent segment 20 is receivable. Registering holes 22 are provided in the segments 18, 20 and the segments are connected together by means of pins extending through the holes 22.

Taking into account the thermal expansion of the reflector 12 due to the increase in temperature of the reflector 12 and the core internals contained therein and the coefficient of thermal expansion of the materials of the segments 18, 20, the strap 16 is constructed of segments having a particular length such that the expansion of the straps 16 matches that of the reflector 12. Hence, the straps 16 provide support to the reflector 12 without inducing stresses resulting from differing thermal expansions.

Reference is now made to FIG. 2 of the drawings, in which reference numeral 30 refers generally to another support strap in accordance with the invention and in which, unless otherwise indicated, the same reference numerals used above are used to designate similar parts.

In this embodiment of the invention, each segment 18, which is formed of austenitic stainless steel, comprises an elongate body which is generally rectangular in transverse cross section. A pair of apertured lugs 32 protrudes from each end of the body 31.

Each segment 20, which is formed of carbon fibre reinforced carbon, includes an elongate body 34 comprising transversely spaced parallel sides 35 interconnected by curved ends 37. If desired a filler material may be provided in the body 34. A pair of spaced apart recesses 36 extends longitudinally inwardly from each end of the body 34. A hole 38 extends through filler material at each end of the body 34 perpendicular to the recesses 36. In use, the lugs 32 are receivable in the recesses 36 and the segments 18, 20 are connected together by a pin 40 extending through the hole 38 and the apertures in the lugs 32 thereby permitting relative pivotal movement of the segments 18, 20 relative to one another about an axis 42 defined by the pin 40.

Reference is now made to FIGS. 3 and 4 of the drawings in which reference numeral 50 refers generally to part of another reactor in accordance with the invention and, unless otherwise indicated, the same reference numerals used above are used to designate similar parts. In this embodiment of the invention, support is provided to the side reflector 12 by a plurality of vertically spaced straps 52, part of one of which is shown in the drawings. Each strap 52 is receivable in an annular recess 54 in an outer surface of the reflector 12.

The strap 52 is similar in structure to the strap 30 except that the lugs 32 are provided at the top and bottom of the body 31 and end portions of the segments 20 are receivable between the lugs 32.

As can best be seen in FIG. 4 of the drawings, the reflector 12 comprises an inner ring, generally indicated by reference numeral 70 of graphite blocks 72 and an outer ring, generally indicated by reference numeral 74 of graphite blocks 14. Each block 12 of the outer ring 74 has an outer surface having a planar central face 76 and two planar outer faces 78 positioned on opposite sides of the central face 76 and inclined rearwardly therefrom. The outer faces 78 of adjacent blocks 12 are co-planar. Each outer face 78 has a width which is approximately half of the width of the central face 16 thereby providing the reflector with a plurality of circumferentially spaced planar faces which are generally of the same width, the planar faces being made up of the central faces 76 and pairs of adjacent outer faces 78.

The reactor 50 includes a core barrel, part of which is generally indicated by reference numeral 80 within which the core is contained. The outer surface of the reflector 12 is spaced radially inwardly from an inner surface 82 of the core barrel 80 so that an annular gap 84 is defined between the reflector 12 and the core barrel over at least part of the height of the reflector 12.

Each of the segments 18 has an inwardly directed reflector contact surface 86 and a parallel outwardly directed surface 88.

A plurality, in the embodiment shown six, of the segments 18 is each provided with a locating formation in the form of an inwardly directed lug 90 which protrudes centrally from the reflector contact surface 86 and is receivable in a complementary recess 92 provided in the central face 76 of one of the blocks 12. Further, each of the segments 18 is provided with a stabilizing formation in the form of a lug 56 which protrudes centrally from the outer surface 88.

In use, the straps 52 are positioned in the recesses 54 with the lugs 90 positioned in the recesses 92. The recesses 54 serve to locate the straps vertically relative to the reflector 12. Further, the lugs 90 and recesses 92 serve to locate the straps circumferentially relative to the reflector 12. The inner surfaces 82 of the segments 18 are parallel with and in contact with or in close proximity to the complementary central faces 76 of the blocks 14. The segments 18, 20 are dimensioned such that the segments 20 are parallel to the adjacent outer faces 78 but spaced therefrom. It will be appreciated, that with this arrangement, the segments 20 will be subjected exclusively to tensile loads. By manufacturing the segments 20 in the form of an elongate loop as described above, they are relatively strong in tension, however, they are not capable of supporting substantial transverse loads. For this reason, it is important that the strap be located circumferentially relative to the reflector. If the strap were to rotate relative to the reflector, the segments 20 could come into contact with the intersections between the central and outer faces 76, 78 leading to transverse loading of the segments 20 as well as point loading on the reflector 12, which could lead to damage to both the strap and the reflector which naturally is undesirable.

Further, as can best be seen in FIG. 4 of the drawings, the dimensions of the lugs 56 are selected such that under normal operational conditions, clearance is provided between the lugs 56 and the inner surface 82 of the core barrel 80 thereby permitting the core and the straps to expand and contract without coming into contact with the core barrel. If, however, the reactor is subjected to exceptional loads, such as would be encountered during a seismic event, the core may move laterally within the core barrel, in which case, the lugs 56 will come into contact with the inner surface of the core barrel and would form a load path whereby the load of the core can be transmitted to the core barrel thereby serving to stabilize the core and limit the lateral movement thereof. If desired, the length of the lugs 56 may be adjustable in order to permit the clearance between the lugs 56 and the inner surface of the core barrel to be adjusted to the desired clearance. Further, the lugs 56 may incorporate damping properties in order to reduce shock loading between the core barrel and the reflector and reduce the risk of damage to the reactor.

The Inventors believe that a support strap in accordance with the invention will provide suitable support to the side reflector of a nuclear reactor. Further, the Inventors believe by virtue of the structure of the support straps they will be relatively simple to manufacture resulting in reduced cost and improved reliability when compared with the prior art. Further, the desired thermal expansion of the support strap can be achieved relatively easily simply by varying the relative lengths of the segments.

1-20. (canceled)

21. A support for supporting a reflector of a high temperature gas cooled nuclear reactor, comprising a strap to be positioned circumferentially around a reflector to be supported, the strap including a plurality of elongate segments that are connected together end to end, and the strap including alternating segments of metal and fiber reinforced ceramic.

22. A support as claimed in claim 21, wherein the metal is austenitic stainless steel.

23. A support as claimed in claim 21, wherein the fiber reinforced ceramic is carbon fiber reinforced carbon.

24. A support as claimed in claim 21, wherein adjacent segments of the strap form a pair interconnected in a manner which permits limited relative movement between adjacent segments.

25. A support as claimed in claim 24, wherein adjacent segments are hingedly interconnected.

26. A support as claimed in claim 21, in which each of at least some of the segments has a reflector contact surface, at least one segment having a locating formation which protrudes from the reflector contact surface.

27. A support as claimed in claim 26, in which each of at least some of the metal segments has a reflector contact surface, the or each locating formation being in the form of a protrusion which protrudes from the reflector contact surface.

28. A support as claimed in claim 26, in which each of at least some of the segments has at least one core barrel contact formation, the or each core barrel contact formation and the or each locating formation being provided on opposite sides of the strap.

29. A high temperature gas cooled nuclear reactor, comprising:
a core having a reflector which defines at least partially a core cavity; and
at least one segmented support strap positioned around the reflector to provide support thereto, the support strap comprising a plurality of interconnected segments, some of the segments being formed of metal and other segments being formed of a fiber reinforced ceramic, the segments being configured such that the coefficient of thermal expansion of the strap corresponds to that of the core.

30. A high temperature gas cooled nuclear reactor as claimed in claim 29, in which the reflector is formed a plurality of graphite blocks, and wherein the support strap to be positioned circumferentially around the reflector, the strap including a plurality of elongate segments that are connected together end to end, and the strap including alternating segments of metal and fiber reinforced ceramic.

31. A high temperature gas cooled nuclear reactor as claimed in claim 30, in which the reflector is generally cylindrical and has an axis which extends vertically, and in which a plurality of support straps extend around the periphery of the reflector at vertically spaced apart positions.

32. A high temperature gas cooled nuclear reactor as claimed in claim 31 in which the reflector includes, on an outer surface thereof, annular recesses within which portions of the straps are receivable.

33. A high temperature gas cooled nuclear reactor as claimed in claim 30, in which each of at least some of the blocks forming an outer surface of the reflector has an outer surface having a planar central face and two planar outer faces positioned on opposite sides of the central face and inclined rearwardly therefrom, each of at least some of the segments of the support strap having an inwardly directed reflector contact surface which extends parallel within close proximity to or in abutment with the central face of one of the blocks.

34. A high temperature gas cooled nuclear reactor as claimed in claim 33, which includes a locator to locate the or each strap circumferentially relative to the reflector.

35. A high temperature gas cooled nuclear reactor as claimed in claim 34, in which the locator includes a protrusion which protrudes from the reflector contact surface of at least one of the segments and which is receivable in a complementary recess in the central face of one of the blocks.

36. A high temperature gas cooled nuclear reactor as claimed in claim 29, which includes a core barrel within which the core is contained, an outer surface of the reflector being spaced radially inwardly from an inner surface of the core barrel so that an annular gap is defined between the reflector an the core barrel over at least part of the height of the reflector, at least some of the segments of the or each strap having stabilizing formations which protrude outwardly from the respective segments and which, under normal operating conditions and loads, are clear of the core barrel and which when the reactor is subjected to abnormal loads, such as may be encountered during a seismic event, make contact with the core barrel and thereby serve to stabilize the core.

37. A method of supporting a reflector of a high temperature gas cooled nuclear reactor which method includes positioning at least one segmented support strap, comprising segments some of which are formed of metal and others of which are formed of fibre reinforced ceramic such that the coefficient of thermal expansion of the strap corresponds to that of the reflector, around the reflector to provide support thereto.

38. A method as claimed in claim 37, which includes positioning a plurality of support straps around the reflector at spaced apart positions.

39. A method as claimed in claim 37, wherein said support strap includes a plurality of elongate segments that are connected together end to end, and wherein the segments alternate between a metal segment and a fiber reinforced ceramic segment.
